(19) United States
(12) Patent Application Publication
(10) Pub. No.: US 2011/0293154 A1
(43) Pub. Date: Dec. 1, 2011

(54) METHOD AND SYSTEM FOR CHARACTERIZING A SAMPLE BY IMAGING FLUORESCENCE MICROSCOPY

(75) Inventors: Alfred Meixner, Bodelshausen (DE); Frank Schleifenbaum, Tubingen (DE)

(73) Assignee: Eberhard Karis Universitat Tubingen, Tubingen (DE)

(21) Appl. No.: 13/144,729

(22) PCT Filed: Jan. 14, 2010
(86) PCT No.: PCT/EP2010/000156

§ 371 Date: Aug. 18, 2011

(30) Foreign Application Priority Data
Jan. 19, 2009 (DE) 10 2009 005 953.9

(51) Int. Cl. G06K 9/00

(52) U.S. Cl. 382/128

(57) ABSTRACT

A method for characterizing a sample by imaging fluorescence microscopy includes detecting fluorescence intensity in a time-resolved fashion after switching off excitation radiation to establish a decay function, representing the decay of the fluorescence intensity over time, for a multiplicity of pixels, comparing the decay functions associated with the pixels to at least one reference decay function to establish an error value for one or more pixels, the error value associated with a pixel being a measure for a deviation of the decay function associated with the pixel from the reference decay function, and generating an image of the sample using the error values.

### RELATED APPLICATIONS

This is a §371 of International Application No. PCT/EP2010/000156, with an international filing date of Jan. 14, 2010 (WO 2010/081690 A1, published Jul. 22, 2010), which is based on German Patent Application No. 10 2009 005 953.9, filed Jan. 19, 2009, the subject matter of which is incorporated by reference.

### TECHNICAL FIELD

This disclosure relates to a method and a system for characterizing a sample by imaging fluorescence microscopy. Options for application can in particular be found in the field of characterizing biological samples.

### BACKGROUND

Fluorescence microscopy is based on the fact that suitable molecules reemit part of the electromagnetic radiation absorbed thereby in the form of radiation with a longer wavelength (lower energy). There are a number of so-called “fluorochromes” (fluorescent dyes), by which microscopic preparations can be marked (flurochromed) and which can thereby be brought to exhibit indirect (or secondary) fluorescence. In the past decades, a number of vital dyes were discovered or developed, which (applied in low concentrations) can mark certain parts of a cell, without causing the latter to die. As a result, it became possible, for example, to follow the substance transport in cells and tissue or to establish the pH value of certain compartments.

In imaging fluorescence microscopy, as used in many fields of biological and medical research and development, ever higher demands are placed on both the spatial and the dynamic resolution of the utilized methods and systems. While the spatial resolution can be optimized by utilizing nonlinear optical properties, the dynamic resolution, i.e., the contrast between the useful signal, produced by a fluorescence marking, and undesired background signals from the surroundings, often is a limiting factor for meaningful and usable examinations. A substantial reason why the signal-to-noise ratio often is very low is the so-called “auto-fluorescence,” particularly of biologically relevant material such as living cells, which can lead to strong background signals. An additional difficulty lies in the fact that the signal components resulting from the auto-fluorescence are often spectrally, i.e., in respect of their wavelength, superposed on conventional fluorescent dyes. Hence, a simple spectral discrimination by using colored filters often is impossible or only achieves insufficient results.

In the mean time, imaging methods based on determining the lifetime of the fluorescence have been developed as an alternative to imaging methods based on the measurement of only fluorescence intensity. So-called “fluorescence lifetime imaging microscopy” (FLIM) is well developed and can be utilized as an option in some commercially available fluorescence microscopes. In one variant of fluorescence lifetime imaging microscopy frequently used, a fluorescing sample is excited by a short laser pulse and the time until a fluorescence photon is registered by a detector is measured. This measurement is repeated a number of times to obtain an intensity-decay statistic which, in the simplest case, describes an exponential reduction in the fluorescence intensity after the excitation radiation is switched off. Then a mono-exponential or multi-exponential function is fitted to the measured data which function can, in the mono-exponential case, for example be described by

$$I ( t ) = {I}_{0} exp ( \frac{- t}{τ} ) . \qquad ( 1 )$$

I(t) is the fluorescence intensity, which depends on the time t and decays over time, starting from an initial intensity I₀. The decay over time is defined by the decay constant τ, which describes that time at which the initial intensity I₀ has dropped to the value 1/e. This value (1/e) describes the mean time during which a molecule remains in the electronically-excited state before it emits a photon.

In classical FLIM techniques, a false-color image of the sample surface is generally produced by recording the fluorescence decay at every pixel and determining the fluorescence lifetime for each pixel. By way of example, an image can be created as a result, which assigns each pixel an individual time constant or lifetime. This affords the possibility of determining, or at least estimating, protein interactions or changes in the intracellular distance amongst others (see, e.g., the journal article “Fluorescence Correlation Spectroscopy and Fluorescence Lifetime Imaging Microscopy,” by Breusegem S., M. Levi, and M. Barry in Review Nephron Exp Nephrol. (2006) 103 (2): pages e41-e49). Other examples are disclosed in the journal article “Fluorescence Lifetime Imaging (FLIM) zur Analyse der lokalen Lipid Umgebung” [Fluorescence lifetime imaging (FLIM) for analyzing the local lipid surroundings] by A. Bülter, B. Krämer, F. Koberling, A. Tannert, T. Korte, and A. Hermann in BIOspektrum 3/05 (11^{th} volume), pages 351 to 353. Reference is made to relevant books in the art for a more detailed description of the fluorescence lifetime microscopy methodology.

Despite the, in principle, great power of fluorescence lifetime microscopy for analyzing even the smallest sample volumes, it often proves impossible to exclude the possibility of errors in the interpretation of the generated images because the fluorescence lifetime of an emitter is dependent on a number of factors, which often are unknown or can only be estimated.

Against this backdrop, it could be helpful to provide a method and a system for characterizing a sample by imaging fluorescence microscopy, which extends the options of commercial methods and systems for high-resolution analysis. More particularly, improvements should be achieved when characterizing biological samples with a strong background signal, e.g., by improving the optical contrast.

### SUMMARY

We provide a method that characterizes a sample by imaging fluorescence microscopy including detecting fluorescence intensity in a time-resolved fashion after switching off excitation radiation to establish a decay function, representing decay of the fluorescence intensity over time, for a multiplicity of pixels, comparing decay functions associated with the pixels to at least one reference decay function to establish an error value for one or more pixels, the error value associated with a pixel being a measure for a deviation of the decay function associated with the pixel from the reference decay function, and generating an image of the sample using the error values.

We also provide a system that characterizes a sample by imaging fluorescence microscopy including an apparatus that detects fluorescence intensity in a time-resolved fashion after switching off excitation radiation to establish a decay function, representing decay of the fluorescence intensity over time, for a multiplicity of pixels, an apparatus that compares the decay functions associated with the pixels to at least one reference decay function to establish an error value for one or more pixels, the error value associated with a pixel being a measure for a deviation of a decay function associated with the pixel from the reference decay function, and an apparatus that generates an image of the sample using the error values.

### BRIEF DESCRIPTION OF THE DRAWINGS

FIG. 1 shows a schematic illustration of essential functional units of an apparatus for determining the fluorescence lifetime by time-correlated single-photon counting (TCSPC).

FIG. 2 shows two fluorescence decay histograms in FIGS. 2A and 2B, in which the number of individual fluorescence photons from a sample volume is plotted as a function of the time t after switching off an excitation radiation, together with possible reference decay functions and deviations therefrom.

FIG. 3 schematically shows three difference fluorescence decay curves for different ratios between useful signal and background signal, wherein the component of the background signal and, hence, the value of the error value, increases from left to right and the component of the fluorescing marker substance reduces from left to right.

FIG. 4 shows a fluorescence intensity image of cell membranes of Arabidopsis cells fluorescence marked with GFP in FIG. 4A, a fluorescence intensity profile along the white line of FIG. 4A (black dots) and associated error values (grey bars) in FIG. 4B, and the intensity profile from FIG. 4B weighted with the aid of the decay shape in FIG. 4C.

FIG. 5 shows fluorescence intensity images of GFP-marked cell membranes separated by a cell wall in FIGS. 5A and 5B, wherein FIG. 5A shows an image without a contrast-increasing correction, FIG. 5B shows an image with a contrast-increasing correction, FIG. 5C shows a comparison illustration of fluorescence intensity profiles of the uncorrected raw data (I) and the weighted fluorescence intensity signals (I′) and FIG. 5D shows an error-value image.

### DETAILED DESCRIPTION

In our method, like in conventional methods with determination of fluorescence lifetime, the fluorescence intensity is detected in a time-resolved fashion after switching off excitation radiation respectively to establish a decay function, representing the decay of the fluorescence intensity over time, i.e., the fluorescence decay, for a multiplicity of pixels. In a further method step, the decay functions associated with the pixels are compared to at least one reference decay function to determine an error value for each of the pixels. The error value associated with a pixel is a measure for a deviation of the decay function associated with the pixel from the reference decay function. As a result of the comparison step between the decay functions associated with the respective pixels and the at least one reference decay function, decay-shape analysis is therefore performed to obtain a similarity or dissimilarity of the local fluorescence decay to a reference decay (represented by the reference decay function) for the respective pixel. The established error values are then used to generate an image of the sample. More particularly, this means that the error values are utilized in a spatially resolved fashion, i.e., separately for the various pixels or groups of pixels, for generating the image.

The term “pixel” refers to an experimental size that emerges from the requirements of the respective application. By way of example, the minimum size of a pixel can, for example, be derived from the minimum spatial resolution d as per d=λ/(2*NA) that can be obtained by the optical system during diffraction-limited imaging and hence can correspond to, e.g., approximately half the utilized wavelength (i.e., λ/2). The pixel can have an even smaller size if suitable super-resolution methods, e.g., sub-diffraction-limit imaging by stochastic optical reconstruction microscopy (STORM), are used, for example down to approximately λ/20. If a smaller spatial resolution is sufficient, a pixel can also be substantially larger and, e.g., correspond to a region with a mean size which, for example, corresponds to the utilized mean wavelength or a multiple thereof.

A pixel can have the same extent in different directions and, for example, have a square shape. However, it can also be larger in a first direction than in a second direction running perpendicular thereto. By way of example, pixels can have a rectangular shape with differing length and width. The extent of a pixel in a particular direction can be fitted to the resolution that is desired in this direction. By way of example, pixels can be narrower in the direction with a high desired spatial resolution than in a direction that is perpendicular thereto, in which only a lower spatial resolution is required.

The pixels for establishing the error value do not necessarily have to correspond to the pixels for establishing the fluorescence intensity signal. The size of the pixels for establishing the decay function is preferably selected such that this results in sufficiently detailed decay statistics that allow a meaningful comparison with a reference decay function. By way of example, if the absolute values of the fluorescence intensity in a sample region are particularly small, the extent of the pixels for establishing the error value can correspondingly be selected to be larger than in regions with high absolute values of the fluorescence intensity. All that is important for generating the image is that an error value is associated with each pixel provided for the image generation. By way of example, each pixel of a multiplicity of adjacent pixels may have a different associated error value. It is also possible for one and the same error value to belong to a group of directly adjacent pixels of an image such that the same error value is associated with a plurality of directly adjacent pixels.

A mono-exponential decay function may be selected as a reference decay function. The latter would emerge if, for example, only a single fluorescent species were present in specific surroundings. Such a situation can be described with sufficient accuracy by a single time constant τ. If use were made of a single marker dye, this would allow identification of regions that have a relatively high proportion of marker dye because the fluorescence decay in these regions should only deviate slightly from the mono-exponential reference decay and correspondingly result in small error values, whereas regions with a smaller proportion of marker dye would be more likely to exhibit a multi-exponential fluorescence decay and correspondingly exhibit larger error values.

Alternatively, or in addition thereto, it is also possible to select a multi-exponential decay function as a reference decay function. In this case, bi-exponential decay functions in particular, i.e., decay functions with precisely two different time constants, may be advantageous because these allow a relatively reliable fit. A reliable multi-exponential fit may be expedient for, e.g., so-called “FRET” systems, which will be explained in more detail below.

A particular field of application of classical FLIM methods, particularly for biological questions, comprises fluorescence resonance energy transfer (FRET) imaging, which is used, for example, for tracing distance changes or molecular interactions of the order of a few nanometers. In this case, excitation energy from a donor, which emits at short wavelengths, is transmitted in a radiationless fashion to an acceptor, which absorbs (and emits) at longer wavelengths. The efficiency of this transmission depends, inter alia, on the 6^{th} power of the distance between the two chromophores. While the fluorescence lifetime of the acceptor is not influenced by the transmission, the donor fluorescence lifetime directly depends on the transmission efficiency. One variant of the method now firstly in a spatially resolved fashion records the fluorescence lifetime of the acceptor by direct excitation. In the process, a FLIM image of the acceptor lifetime is obtained. The values thus obtained can be used as fixed parameters for recording a FLIM image that is generated by excitation of the donor (in the process, the emission from the acceptor and the partly fluorescence-quenched donor are detected at the same time). By knowing the spatially-resolved acceptor lifetime, it is now possible to generate a bi-exponential reference decay function, the unknown parameters of which represent the lifetime and intensity amplitude of the donor decay. If a strong auto-fluorescence contributes to the measured signal in the process, this results in additional decay constants and the measured decay deviates from the reference function. Hence, the method can also be applied in complex coupled multi-chromophore systems.

It is possible to derive further information relating to the examined sample by correlating a plurality of comparisons, wherein, for example, a comparison is undertaken in some examples with both a mono-exponential and a multi-exponential reference decay function.

In some instances, the error values established for the individual pixels are directly converted into a false-color image or another two-dimensional or three-dimensional representation of the examined sample region, in a spatially resolved fashion, to visualize the respective error values or the deviations from the reference decay function established for the individual sample volumes. A spatially resolving analysis of the error values in an error-value image can be used directly for characterizing samples, more particularly biological samples.

By way of example, analyzing the decay shape can make it possible to visualize and directly determine experimentally the ratio between useful signal and background signal. By way of example, this affords the possibility of tracing, e.g., the distribution of a fluorescence marking in a tissue, a living cell or another sample material. By way of example, this can determine the marker proportion, i.e., the proportion of the fluorescent dye used for marking, even in weakly fluorescent sample areas. By way of example, if only little sample material is present in a sample region, the measured fluorescence intensity is low, and so such regions would appear correspondingly inconspicuous, e.g., dark, in an image based on fluorescence intensities. Nevertheless, the relative proportion of the fluorescence marking may possibly be higher than average in such region, for example, as a result of agglomeration effects. Such information relating to the distribution of substances in the sample material becomes accessible using the proposed method variant. Knowledge of the ratio between marked sample material and non-marked sample material can be utilized in, e.g., biological samples to trace intracellular transport or storage processes. Such analysis, optionally paired with intensity-sensitive methods, can be applied in a beneficial fashion in many areas of the life sciences—from fundamental questions to effect analyses of novel pharmaceuticals.

In one example, a spatially resolved detection of the fluorescence intensity is carried out for a multiplicity of pixels to establish fluorescence intensity signals associated with the pixels and the fluorescence intensity signals are weighted by the error values belonging to the pixel to establish weighted fluorescence intensity signals. Then, one or more images of the sample are generated using the weighted fluorescence intensity signals. This method variant, which contains a “decay-shape weighting” of the fluorescence intensity signals allows a significant increase in the optical contrast in imaging fluorescence microscopy. The term “optical contrast” describes the intensity ratio between the useful signal and the (generally undesired) background signal. Such an increase in contrast is of great interest, particularly in the area of biological samples, because these samples in particular often have very high background signal intensities, which are predominantly generated by cellular auto-fluorescence. Weighting the fluorescence intensity signals with the aid of the error values established from the decay functions can be utilized for contrast control because this provides the option of robustly suppressing the background signal without making assumptions and at the same time increasing the weighting of the useful signal.

In one method variant, the error squared χ² value is determined for each pixel when comparing the decay functions associated with the pixels to a reference decay function, as a result of which the evaluation becomes particularly simple and quick. The error value can directly correspond to the error squared χ² or be derived therefrom. By way of example, the value of χ⁴ can be utilized as an error value. Methods for determining the error squared according to the least squares method are already frequently implemented in many commercial systems and can be utilized for this purpose. The error squared value is a measure for the deviation of a fitted function from experimental values and can therefore be utilized to determine the quality of the fit. As the deviation of a measured fluorescence decay from a reference decay, e.g., a mono-exponential behavior, increases, the larger the χ² value will be and, accordingly, the more background signal was recorded. The error value therefore provides a quantitative measure for determining the component of useful signals or background signals. Other methods for determining the deviation between the measured decay function and a reference decay function are likewise possible, for example, an integration of the measured curve and the reference curve and a subsequent comparison of the obtained values.

In one method variant, an image of the sample using the error value is generated by virtue of the fact that the values for the fluorescence intensity established for each pixel are multiplied by the reciprocal value of the established error value, for example, the reciprocal value of the error squared χ², or a value proportional thereto. In this fashion, a background signal, which corresponds to a high error value, is weighted less while useful signals, which correspondingly correspond to smaller values of the error value, are increased. Other options for weighting the fluorescence intensity signals with the aid of the error parameters are likewise possible.

We also provide a system for characterizing a sample by imaging fluorescence microscopy, comprising:
an apparatus for detecting the fluorescence intensity in a time-resolved fashion after switching off excitation radiation to establish a decay function, representing the decay of the fluorescence intensity over time, for a multiplicity of pixels;
an apparatus for comparing the decay functions associated with the pixels to at least one reference decay function to establish an error value for each pixel, the error value associated with a pixel being a measure for a deviation of the decay function associated with the pixel from the reference decay function; and
an apparatus for generating an image of the sample using the error values.

By way of example, the system can comprise a confocal microscope system to be able to examine very small sample volumes with a high spatial resolution and, optionally, to be also able to undertake examinations at different sample depths, which can be processed to generate three-dimensional (spatial) images of the examined sample region.

Various of our systems can, in the form of additional program parts or program modules, be implemented in the evaluation software of already existing systems for characterizing samples by imaging fluorescence microscopy.

Hence, we further provide a computer program product which more particularly is stored on a computer-readable medium or implemented as a signal, wherein the computer program product causes the computer to execute our method or a preferred version thereof when the computer program product is loaded into the memory of a suitable computer and executed by a computer.

These and further features emerge not only from the appended claims but also from the description and the drawings, wherein the individual features can respectively be implemented on their own or in groups in the form of sub-combinations in an example and in other fields and can constitute advantageous variations.

Preferred methods and systems will be explained below on the basis of examples, which make use of the equipment of commercial confocal fluorescence microscopes with a fluorescence lifetime imaging microscopy (FLIM) option. By way of example, fluorescence microscopes with individual-molecule sensitivity, as produced and distributed under the name “MicroTime® 200” by PicoQuant GmbH, Berlin, are suitable for carrying out the method. The confocal microscope system equipped for imaging fluorescence microscopy contains hardware and software for time-correlated single-photon counting (TCSPC) for recording data and furthermore has apparatuses for establishing the decay of the fluorescence intensity over time after exciting the fluorescence by a short laser pulse.

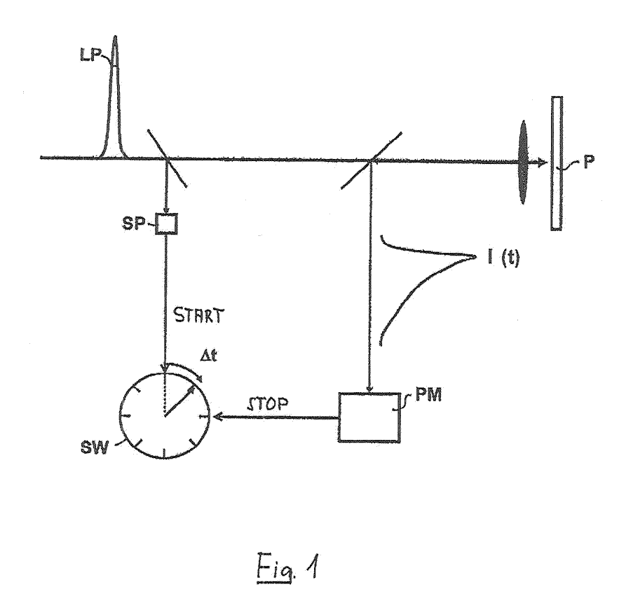

The principle of determining the fluorescence lifetime by time-correlated/single-photon counting is first explained in more detail on the basis of FIG. 1. In this method, a fluorescing sample P is excited by a short, ideally delta-shaped, laser pulse LP. At the same time, a start signal START is generated via a synchronization pulse SP and starts a stop watch SW, which is stopped by a stop pulse STOP as soon as a fluorescence photon is registered on the detector of a photon multiplier PM. This measurement is repeated a number of times.

After switching off the excitation radiation, i.e., after the reception of the laser pulse, the excited molecules remain in the excited state for a certain amount of time (lifetime) and then return to the ground state, with at most one fluorescence photon being emitted per excited molecule. Most excited molecules only have a relatively short lifetime in the excited state, but more time passes in other molecules before they fall back to the ground state and produce a fluorescence photon. Since most molecules only have a relatively short lifetime after switching off the excitation radiation, the fluorescence intensity is highest directly after switching off the excitation radiation and becomes continuously weaker because molecules with a longer life in the excited state are less common than shorter-lived molecules. The decay of the fluorescence intensity over time, like radioactive decay, can in the simplest case be described by a mono-exponential decrease in the fluorescence intensity. In the process, an exponential function serving as a reference decay function can be fitted to the experimental data as per

$$I ( t ) = {I}_{0} exp ( \frac{- t}{τ} ) . \qquad ( 1 )$$

In practical terms, the reference decay function is convoluted before this with a previously recorded instrument response function (IRF). In the description as per equation (1) the decay constant τ represents the time at which the initial intensity I₀ has dropped to the value 1/e. Hence, this value describes the mean time that the molecule remains in the electronically excited state before emitting a photon.

The fluorescence lifetime, which can be established via the decay constant τ, generally changes with, e.g., the ion-concentration ratios in the surroundings of the excited molecule and can therefore be utilized as a measurement probe acting on a molecular level. The local refractive index, possible energy transfer partners, or the flexibility of the local surrounding matrix can also have a significant influence on the fluorescence lifetime.

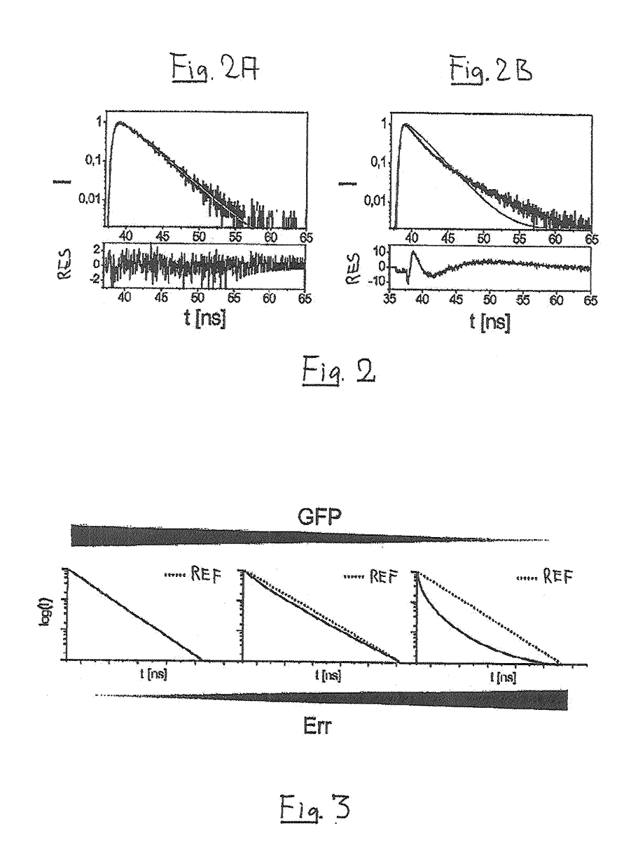

FIGS. 2A and 2B show typical TCSPC histograms of photons that were emitted from a sample volume of interest. The corresponding fluorescence lifetime can be deduced from such a histogram or the data on which it is based by fitting an exponential function, e.g., as per equation (1), and determining the decay constant τ from this. Typical lifetimes are often on the order of a few nanoseconds (ns). The errors RES of the fit (often referred to as residuals) are respectively illustrated below the histograms. A relatively low and, over time, relatively constant error level as in FIG. 2A indicates a relatively good fit. High values of the residuals and/or great variations over the time t, as shown in FIG. 2B, indicate that the experimentally registered fluorescence decay can only be poorly described by the selected fit function.

In classical FLIM techniques a false-color image, for example, of the observed sample region is generated on the basis of these fluorescence lifetime data by recording the fluorescence decay at each pixel and determining the lifetime for the respective pixels and displaying these using a false color. As a result, an image is obtained thereby that assigns each pixel an individual time constant. However, such methods reach their limits as soon as the background signal becomes too dominant and, more particularly, decays with a similar time constant as the useful signal originating from the fluorescence marking.

In the following text a method variation will now be described that allows effective discrimination between useful signals and background signals. In the process, the fact that a fluorescence marker dye typically only has a single time constant of the fluorescence decay is utilized such that the decrease in the fluorescence intensity over time accordingly substantially obeys a simple exponential relation. This assumption particularly holds true when very small sample volumes are examined, as is the case in, e.g., the optical image from a confocal microscope. In contrast thereto, the background signals are generally very unspecific because a multiplicity of possible emitters can contribute to the measured intensity decrease. Since each different emitter generally has its own individual decay constant, the fluorescence decay measured for the background generally is a superposition of the decay curves of many individual emitters and therefore cannot, or only with a significantly larger error, be described by a simple experimental decay function. These relationships are utilized in one method variant for increasing the dynamic resolution, i.e., the optical contrast, of the imaging method.

In this method variation, fluorescence decay is recorded at each pixel of interest, that is to say the fluorescence intensity is detected in a time-resolved fashion after switching off an excitation radiation to establish the decay of the fluorescence intensity over time (i.e., the fluorescence decay). The latter is normally described by a decay function, similar to the one shown in FIG. 2, for each pixel of interest. Moreover, the fluorescence intensity is detected in a spatially resolved fashion for all pixels of interest to use this to establish the fluorescence intensity signals associated with the pixels. The fluorescence intensity can be established by integration over time of that data that is established during the detection in a time-resolved fashion of the fluorescence decay.

Then a comparison is carried out between the decay functions associated with the pixels and at least one reference decay function to establish an error value for each of the pixels. In the example described here, the reference decay function represents a mono-exponential function as per equation (1). The error value associated with a pixel in this case is a measure for a deviation of the decay function associated with the pixel from the reference decay function. The quality of the fit can be quantified in the example, e.g., by the error squared χ². The more the useful signal has now contributed to the measured intensity decay, i.e., as the proportion of the useful signal in the measured overall signal increases, the better the measured curve will be described by a mono-exponential function and, consequently, the smaller the value of the error squared is. In contrast, if the background signal substantially contributes to the measured intensity signal, the error value obtains relatively large values. This relationship is schematically illustrated in FIG. 3.

FIG. 3 shows idealized fluorescence decay curves for different ratios between the useful signal and the background signal. The three graphs in each case plot the logarithm of the fluorescence intensity I over time t. The component of the useful signal that originates from a fluorescence marker (GFP) drops from left to right, i.e., from FIG. 3A to FIG. 3C. In the case of a relative high component (FIG. 3A), this then results in a largely linear relationship between the logarithm of the fluorescence intensity and the time, in accordance with a mono-exponential decay. The corresponding error value Err when fitting it to a mono-exponential reference function REF is correspondingly small. As the component of the intensity originating from the fluorescence marker (useful signal) in the overall signal decreases, the fit of the mono-exponential function to the measured values becomes worse, which manifests itself in the graphs by an increasing deviation of the relationship from a linear relationship (reference decay function REF, illustrated by a dashed line). Accordingly, as the component of the background signal relative to the useful signal in the overall signal increases, so does the error value Err of the fit. Hence, the more the background contributes to the measured signal, the more the decay profile deviates from a mono-exponential behavior and, accordingly, the larger the error value is in the case of a simple exponential fit.

The error values belonging to the pixels are now utilized during imaging by weighting the fluorescence intensity signals for each pixel by the error value belonging to the pixel. Hence, an essential aspect of this method variant does not consist of determining the fluorescence lifetime τ and using it for imaging, but rather consists of using the quality of the fit, parameterized by a suitable error value, as a rating parameter and taking it into account during the imaging. In this case, the fact that a fluorescence decay only follows a simple exponential function if precisely one fluorescing species (in a homogeneous environment) contributes to the decay with a single decay constant is taken into account. Whereas this is very much the case in a targeted fluorescence marking, this condition is not satisfied in a region with strong background auto-fluorescence. This is because in the latter case many different emitters with respectively individual decay constants contribute to the measured signal, and so the resulting fluorescence decay is generally distinctly multi-exponential.

The method variation described here uses the error squared χ² value, i.e., a measure for the deviation of the fitted function from the experimental values, to determine the quality of the fit, i.e., to determine the error value applicable for each pixel. A larger χ² value indicates that the measured decay deviates more strongly from a mono-exponential behavior, and so, accordingly more background signal was recorded. Thus, the error value provides a quantitative measure for determining the component of useful signal and background signal.

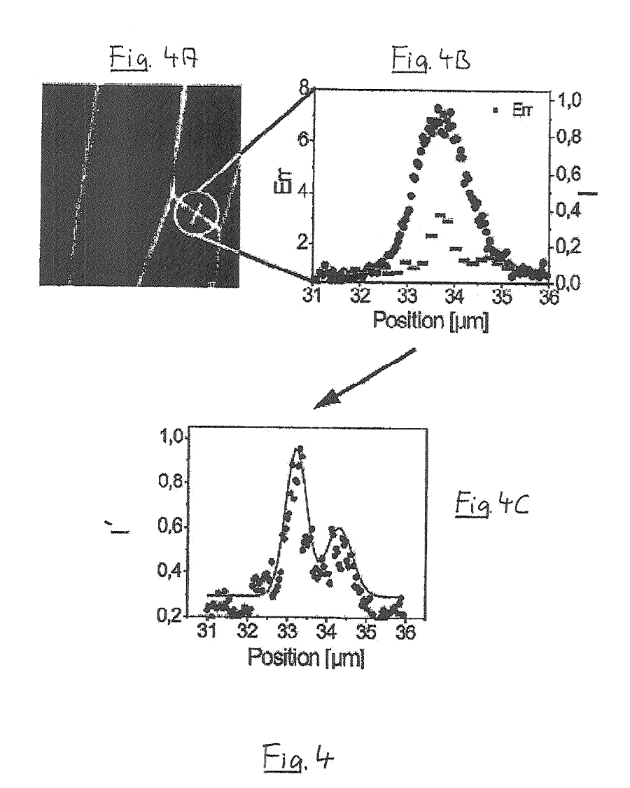

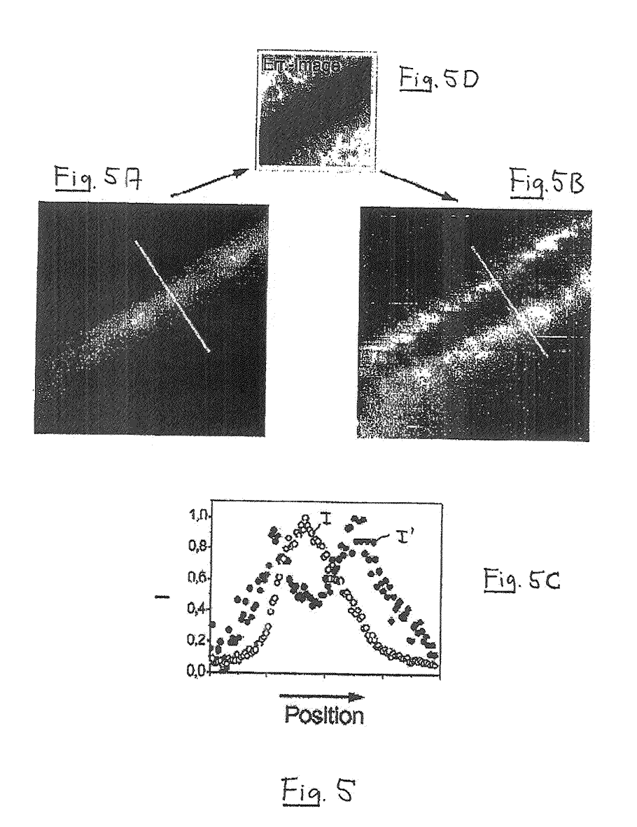

In the method variation described here, the value of the fluorescence intensity measured for each pixel is multiplied by the reciprocal value of the established error squared, i.e., by 1/χ². This results in a less strong weighting of the background signal (high χ² value) while the useful signal (low χ² value) is increased. The increase in contrast in imaging methods made possible by this is explained in more detail below using FIGS. 4 and 5.

The method was tested using Arabidopsis plant cells, which were marked by the green-fluorescing protein GFP. This type of sample constitutes a particular challenge for fluorescence microscopy because, first, Arabidopsis has a very high background signal and, second, the background signal moreover overlaps very strongly in terms of its spectrum with the emission spectrum of the GFP marking, as a result of which it is not or hardly possible to distinguish spectrally between fluorescence marking and background signal. Moreover, the decay constants of cell background and GFP marking lie in a very similar range (between 3 ns and 4 ns), and so a discrimination with classical fluorescence lifetime microscopy methods is hardly possible.

FIG. 4A shows a conventionally established fluorescence intensity image of Arabidopsis cells, the cell membranes of which were selectively fluorescence-marked with GFP. Intensity profile measurements were carried out in the region marked by the white line on the right, in which two cell membranes separated by a cell wall are situated.

FIG. 4B shows a fluorescence intensity profile along the white line in FIG. 4A (black dots). The fluorescence intensity I is specified in arbitrary units. The intensity profile exhibits a single maximum; i.e., it proves to be impossible to resolve the two cell membranes separated by the unmarked cell wall. A substantial reason for this lies in the high fluorescence background signal in the unmarked cell wall, which prevents targeted observation of the cell membranes.

FIG. 4B shows the values for the error values Err (left scale) associated with the pixels in the form of cross beams. It is obvious from the width of the cross beams, which often extend over a plurality of measurement positions, i.e., over a plurality of adjacent pixels, that the same error-value level dominates relatively large contiguous regions. Nevertheless, a specific error value is unambiguously assigned to each intensity value. The error-value level is greatest in the region of the intensity maximum at approximately 33.5 μm (bad fit to a mono-exponential decay curve), has a local minimum at approximately 34.3 μm and a small local maximum at approximately 34.7 μm.

For comparison with FIG. 4B, FIG. 4C shows the decay-shape weighted intensity profile from FIG. 4B. In the decay-shape weighting, the temporal decay curves of the fluorescence intensity of the individual pixels were compared to a mono-exponential reference decay function. An error squared χ² value was established therefrom for each pixel and it forms a measure for the deviation of the fitted function from the experimental values to establish the quality of the fit for each pixel. The grey bars in FIG. 4B specify the error values Err. The weighting factors, which each corresponded to the reciprocal value of the established error squared, were calculated from these. The measured intensity values were then multiplied by the weighting factors to obtain the weighted intensity values I′ shown in FIG. 4C.

The background of the fluorescence from the cell wall is effectively suppressed by applying this method, and so the two cell membranes that were marked by GFP can now be resolved separately. In FIG. 4C, the two cell membranes are situated on both sides of the local minimum of the decay-shape weighted intensity profile I′ at approximately 33.8 μm. The position of the local minimum corresponds to the position of the cell wall, with the local maxima existing next to it on both sides representing the selectively marked cell membranes with a relatively large marker component.

FIG. 4C vividly shows that the utilized measurement system has a sufficient spatial resolution capability to be able to illustrate separately cell membranes that lie close to one another. However, this good spatial resolution capability is not fully utilized by conventional methods (cf. FIG. 4B) because the dynamic resolution, i.e., the optical contrast, is insufficient. This disadvantage is removed in the method variant, proposed here, with decay-shape weighted intensity profiles.

FIGS. 5A to D clarify how this contrast-increasing method can affect the graphical display. FIGS. 5A and 5B each show fluorescence intensity images of GFP-marked cell membranes separated by a cell wall, with FIG. 5A showing the image generation without contrast correction and FIG. 5B showing the image generation with contrast correction by decay-shape weighted intensity profiles.

FIG. 5D shows the associated intensity profiles along the profile lines in FIGS. 5A and 5B. The unfilled dots respectively show the raw data from the uncorrected intensities I from FIG. 5A, while the black dots show the weighted intensities I′ after the decay-shape weighting.

While the greatest intensity in the uncorrected image (FIG. 5A) occurs in the region of the (unmarked) cell wall, two separate maxima can be identified in the corrected image (FIG. 5B), which originate from the fluorescence of the marked cell membranes. It was possible to suppress the auto-fluorescence by approximately a factor 3 in the example, and so the membranes, which appear to be brighter, can even be clearly distinguished from the intermediate unmarked cell walls, which appear to be darker, in the pictorial display (FIG. 5B).

FIG. 5D shows a section of an image that was generated solely on the basis of the established error values Err, i.e., an error value image. The dark transverse stripe running from bottom left to top right in this case represents the regions with particularly large error values, i.e., a relatively large background signal, which originates from the region of the unmarked cell membrane. No intensity information was processed when generating this image. This image merely represents the ratio between useful-signal emission and background emission.

Our methods and systems are mainly explained on the basis of examinations on biological samples. However, this disclosure is not restricted thereto and can also be used for other samples, e.g., samples that show the auto-fluorescence of polymer matrices. The method provides the option of possibly examining samples with individual molecule sensitivity and can increase the sensitivity of conventional methods. However, the method can also be applied for examinations of ensembles.

1. A method that characterizes a sample by imaging fluorescence microscopy comprising:
detecting fluorescence intensity in a time-resolved fashion after switching off excitation radiation to establish a decay function, representing decay of the fluorescence intensity over time, for a multiplicity of pixels;
comparing decay functions associated with the pixels to at least one reference decay function establish an error value for one or more pixels, the error value associated with a pixel being a measure for a deviation of the decay function associated with the pixel from the reference decay function; and
generating an image of the sample using the error values.

2. The method as claimed in claim 1, wherein the reference decay function is a mono-exponential decay function.

3. The method as claimed in claim 1, wherein the reference decay function is a multi-exponential decay function.

4. The method as claimed in claim 1, wherein the error values established for the individual pixels are directly converted into a false-color image or another two-dimensional or three-dimensional representation of an examined sample region.

5. The method as claimed in claim 1, further comprising:
detecting the fluorescence intensity for a multiplicity of pixels in a spatially resolved fashion to establish fluorescence intensity signals associated with the pixels;
weighting the fluorescence intensity signals with the error value associated with the pixel to establish weighted fluorescence intensity signals; and
generating an image of the sample using the weighted fluorescence intensity signals.

6. The method as claimed in claim 1, wherein an error squared χ² value is determined for each pixel when comparing decay functions associated with the pixels to a reference decay function.

7. The method as claimed in claim 1, wherein an image of the sample using the error value is generated multiplying the values for the fluorescence intensity established for each pixel by a reciprocal value of an established error value or a value proportional thereto.

8. The method as claimed in claim 1, wherein time-correlated single-photon counting (TCSPC) detects the decay function.

9. The method as claimed in claim 1, wherein a confocal microscope system detects fluorescence signals.

10. A system that characterizes a sample by imaging fluorescence microscopy comprising:
an apparatus that detects fluorescence intensity in a time-resolved fashion after switching off excitation radiation to establish a decay function, representing decay of the fluorescence intensity over time, for a multiplicity of pixels;
an apparatus that compares the decay functions associated with the pixels to at least one reference decay function to establish an error value for one or more pixels, the error value associated with a pixel being a measure for a deviation of a decay function associated with the pixel from the reference decay function; and
an apparatus that generates an image of the sample using the error values.

11. (canceled)

12. The system as claimed in claim 10, further comprising a confocal microscope system.

13. A computer program product which stored on a computer-readable medium or implemented as a signal, and executes a method as claimed in claim 1 when said computer program product is loaded into a memory of a computer and executed by the computer.

14. The method as claimed in claim 2, wherein the reference decay function is a multi-exponential decay function.

15. The method as claimed in claim 2, wherein the error values established for the individual pixels are directly converted into a false-color image or another two-dimensional or three-dimensional representation of an examined sample region.

16. The method as claimed in claim 3, wherein the error values established for the individual pixels are directly converted into a false-color image or another two-dimensional or three-dimensional representation of an examined sample region.

17. The method as claimed in claim 2, further comprising:
detecting the fluorescence intensity for a multiplicity of pixels in a spatially resolved fashion to establish fluorescence intensity signals associated with the pixels;
weighting the fluorescence intensity signals with the error value associated with the pixel to establish weighted fluorescence intensity signals; and
generating an image of the sample using the weighted fluorescence intensity signals.

18. The method as claimed in claim 3, further comprising:
detecting the fluorescence intensity for a multiplicity of pixels in a spatially resolved fashion to establish fluorescence intensity signals associated with the pixels;
weighting the fluorescence intensity signals with the error value associated with the pixel to establish weighted fluorescence intensity signals; and
generating an image of the sample using the weighted fluorescence intensity signals.

19. The method as claimed in claim 4, further comprising:
detecting the fluorescence intensity for a multiplicity of pixels in a spatially resolved fashion to establish fluorescence intensity signals associated with the pixels;
weighting the fluorescence intensity signals with the error value associated with the pixel to establish weighted fluorescence intensity signals; and
generating an image of the sample using the weighted fluorescence intensity signals.

20. The system as claimed in claim 11, further comprising a confocal microscope system.
